(19) United States
(12) Patent Application Publication
(10) Pub. No.: US 2003/0180188 A1
(43) Pub. Date: Sep. 25, 2003

(54) Robotic fluid handling, stirring, and pipetting method and apparatus

(76) Inventors: Samuel G. Michael, Silver Spring, MD (US); L. Eric Wallgren, Bethesda, MD (US)

Correspondence Address: Daniel R. Gropper, PC, 9908 Dale Ridge Ct., Vienna, VA, 22181, US

(21) Appl. No.: 10/105,981

(22) Filed: Mar. 21, 2002

(51) Int. Cl. G01N 35/00; B01L 3/02

(52) U.S. Cl. 422/99; 422/100; 436/43; 436/181

(57) ABSTRACT

A method and apparatus for automatically inserting fluids into vessels, stirring the fluids within the vessels and withdrawing the stirred fluids from the vessels by vacuum. A movable arm supports fluid delivery pipettes, a stirring device and a fluid withdrawal system. A microprocessor automatically controls the alignment and operation of a movable arm and its appended operational implements.

### FIELD OF THE INVENTION

This invention relates to an automated method and apparatus for inserting and/or removing fluids from an array of pipettes having a mechanism to stir the contents of each pipette.

### BACKGROUND OF THE INVENTION

There are many known multiple-sample analyzer systems, some including stirrers.

One example is U.S. Pat. No. 5,207,986 to Kadota which teaches an analysis unit having a stirrer, although this element is neither shown in the drawings nor described in detail in the specification. See Col. 4, lines 30-32.

Related U.S. Pat. Nos. 5,902,549 to Mimura and 6,019,945 to Ohishi similarly teach analyzer units with stirring mechanisms in block diagrammatic form, such as FIG. 2, references 65 and 66 and FIG. 3, references 13a and 13b.

Each of these patents teach methods and an apparatus for testing multiple samples where the samples are disposed in movable arrays, but the details and operational functionality of the stirrer in each of these patents are not disclosed. This patent teaches a novel method and automated apparatus for inserting and withdrawing fluids from pipettes and stirring the contents within the pipette.

### SUMMARY OF THE INVENTION

One of the objects of the instant invention is automatically aligning a fluid head with a pipette and inserting and/or withdrawing liquids from the pipette and stirring the liquids in the pipette.

Another object of the instant invention is to power the stirring mechanism by air or electricity.

Another object of the instant invention is to utilize a stirring apparatus configured of economical and functional bent wire.

Another object of the instant invention is to utilize an extendible arm to support and control the liquid, vacuum and stirring functions with respect to the pipette or other vessel.

Another object of the instant invention is to provide means for releasably controlling the location and movement of the pipettes or other vessels.

### BRIEF DESCRIPTION OF THE DRAWINGS

FIG. 1 is a perspective view of the invention.

FIG. 2 is a side cut away view of the operational arm in the retracted position showing the stirrer.

FIG. 3 is a side cut away view of the operational arm in the extended position showing the stirrer.

FIG. 4 is a side view of the operational arm and the supporting arm showing a suction or fluid delivery tool.

FIG. 5 is a side view of the operational arm and the supporting arm showing a suction or fluid delivery tool.

### DETAILED DESCRIPTION OF THE INVENTION

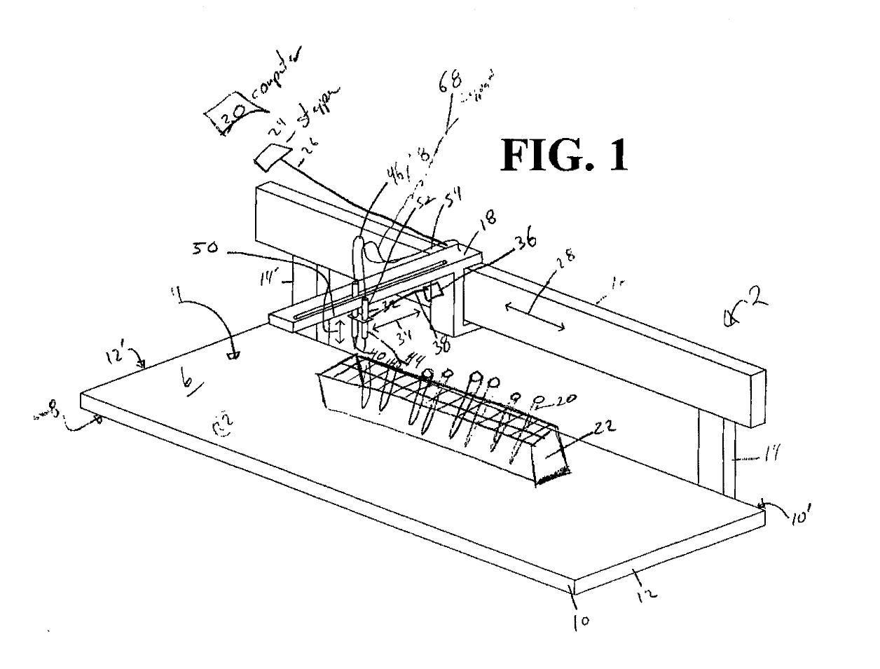

Referring to FIG. 1, apparatus 2 has base 4 to support the apparatus structure. Base 4 has top 6, a bottom 8, edges 10 and 10′ and ends 12 and 12′. Alternatively, the base can be any planar surface, such as a work table, which can rigidly and securely support and position apparatus 2.

Cross arm 16 is supported at the appropriate distance above top 6 of base 4 by vertical supports 14 and 14′. Vertical supports 14 and 14′ can be attached to base 4 or to a work table or surface in any commonly known or hereinafter developed manner.

Support arm 18 is slidably disposed on, and is supported by, cross arm 16. Vertical supports 14 and 14′ are spaced sufficiently apart to permit support arm 18 to move horizontally across all of the pipettes, centrifuge tubes, or vessels 20 disposed in vessel holder 22. Vessel holder 22 may be disposed on the top 6 of base 4.

Vessel holder 22 may be any type of support for one or a plurality of vessels 20. Vessel holder 22 must releaseably support each vessel 20 in rigid and precise alignment relative to the planes formed by top 6 of base 4 and support arm 18.

The movement of support arm 18 along cross arm 16 may be controlled by any known or in the future developed precisely controlled stepper mechanism, generally shown as 24, which may have an extendible controlling arm 26 disposed between stepper mechanism 24 and cross arm 18. The stepper mechanism 24 may be powered by electricity, air, magnetism or by any future developed power source. The movement of the support arm 18 in the horizontal direction, as shown by arrow 28, along cross arm 16 is controlled by stepper mechanism 24 which is in turn controlled by computer 30. Computer 30 may be a personal computer, microcontroller or any other programmable logic device created in the future.

A tool holder 32 is slidably depended from support arm 18 and moves in a horizontal plane along support arm 18 as shown by arrow 34. Tool holder 32 slidably moves along support arm 18 and its movement is controlled by stepper mechanism 36 and tool holder stepper arm 38. Tool holder stepper mechanism 36 may be powered by electricity, air, magnetism or by any future developed power source. The movement of the tool holder 32 in the horizontal direction, as shown by arrow 34, along support arm 18 is controlled by stepper mechanism 36 which is in turn controlled by computer 30. Computer 30 may be a personal computer, microcontroller or any other programmable logic device created in the future.

Tool holder 32 may hold may different types of tools in existence or developed in the future. For many scientific and biotechnical applications, the tools may normally consist of a fluid delivery tool 40, a fluid suction tool 42 and stirrer mechanism 44.

Tool holder 32 also has means to move each tool 40, 42, 44 in an axial vertical direction with respect to the top 6 of base 4 as is shown by arrow 50. Tool holders 32 vertical movement of tools 40, 42, 44 in the direction of arrow 50 may be powered by electricity, air, magnetism or by any future developed power source. The vertical movement is controlled by one or more vertical stepper mechanisms 52 which is in turn controlled by computer 30. Computer 30 may be a personal computer, microcontroller or any other programmable logic device created in the future. One or more vertical stepper mechanisms 52 may be connected to support arm 18 for support, positioning and alignment with respect to vessels 20 and vessel holder 22.

Connections between tools 40, 42 and 44 to external sources of suction, fluids to be inserted into tools, and power and control signals are provided by control and supply lines 46, 48 and 54. These can be any commonly known and used supply lines and power and control lines as needed for each particular specific application. These lines 46, 48 and 54 will be flexible to permit tool holder 32 to traverse support arm 18 in the direction of arrow 34 and will be supported by usual means such as support wires or springs 68 so as to prevent crimping or entanglement while in operation.

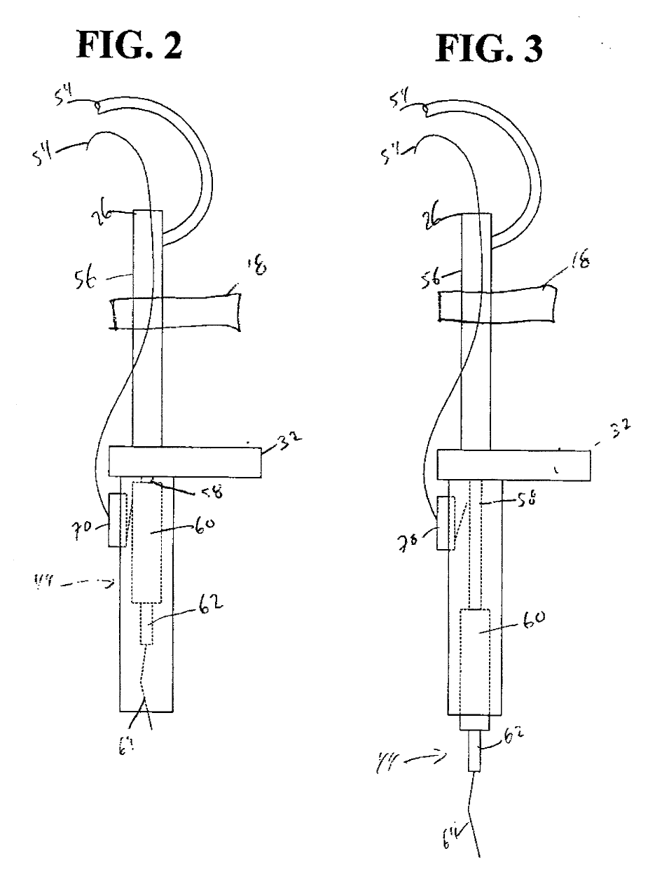

FIGS. 2 and 3 show a cut away side view of stirrer 44 with power and control lines 54 mounted on tool holder 32 which is in turn mounted on support arm 18. In the configuration shown, tool holder 32 consists of a pneumatically driven cylinder 56 with extendible arm 58. Stirrer motor 60 is mounted on the distal end of extendible arm 58. Stirrer tool shaft 62 is rotatably connected to stirrer motor 60 and is configured to accept different stirrer wires 64 for different applications. Stirrer wires 64 can be made from any stiff material such as steel. A bend 64 is placed in each stirrer wire 64 so that rotation of stirrer wires 64, when stirrer wire 64 is located in fluid within a vessel 20, causes fluid within each vessel 20 to be mixed. Stirrer bend 64 is configured at such an angle so that stirrer wire 64 can fit within each vessel 20 without contacting the sides of each vessel. A stop or limit switch 70 may be added to stirrer 44 to sense the vertical position of extendible arm 58.

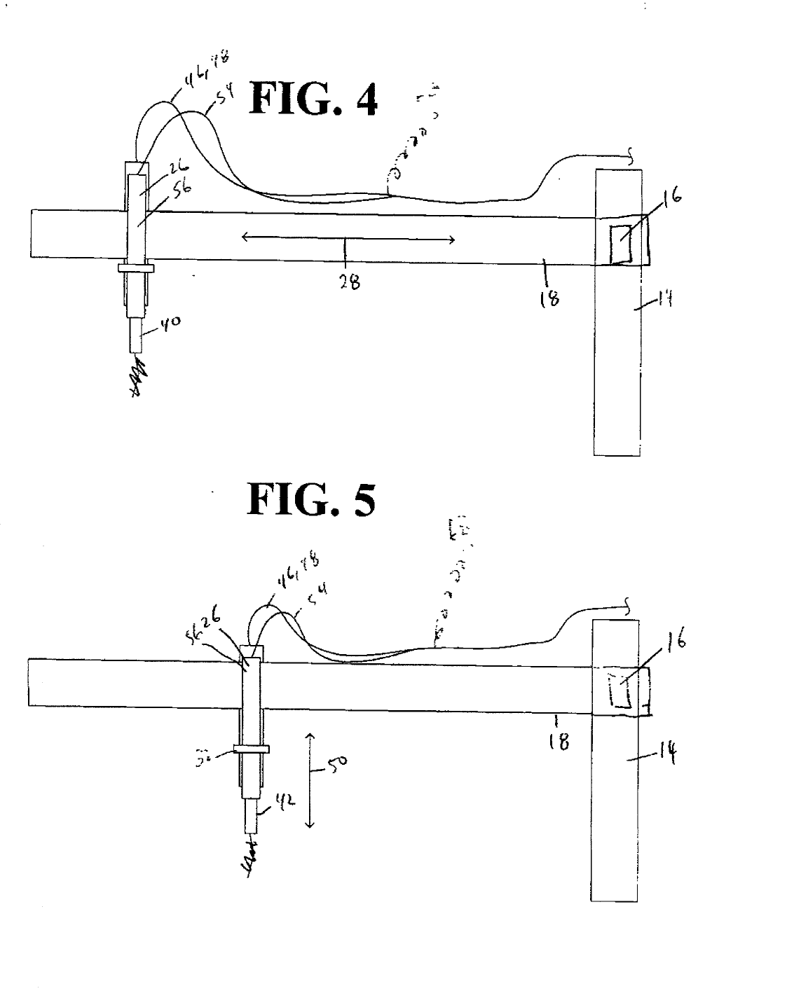

FIGS. 4 and 5 shows a side view of fluid delivery 40 and fluid suction 42 tools. These tools are located in alignment with a vessel 20 by computer 30 and fluids are either pumped into or sucked out of vessels 20 through fluid pipes 46 and 48.

In operation, at least one vessel 20 is inserted in an aperture of a vessel holder 22 which is in turn supported on a base 4. The location of vessel 20 on vessel holder 22 is automatically detected by a computer 30 or other programmable logic device. A stirring 44, and/or a device to insert or withdraw fluids 40, 42 from vessel 20 is inserting into vessel 20 and the fluids in vessel 20 are mixed, inserted and/or withdrawn.

It is to be understood that while certain forms of the present invention have been illustrated and described herein, it is not to be limited to the specific forms or arrangement of parts described and shown.

What we claim is:

1. An apparatus for automatically stirring and mixing the contents of a vessel comprising:
a) a base;
b) a movable arm slidably connected to said base;
c) a stirring device movably connected to said movable arm;
d) at least one vessel;
e) means for supporting said at least one vessel connected to said base;
f) means for automatically aligning said stirring device with said at least one vessel;
g) means for removably inserting said stirring device in said at least one vessel; and,
h) means for rotating said stirring device while said stirring device is disposed in said at least one vessel.

2. An apparatus for automatically stirring and mixing the contents of a vessel, as recited in claim 1, wherein said means for rotating said stirring device while said stirring device is disposed in said at least one vessel further comprises an electric motor.

3. An apparatus for automatically stirring and mixing the contents of a vessel, as recited in claim 1, wherein said means for rotating said stirring device while said stirring device is disposed in said at least one vessel further comprises an air powered motor.

4. An apparatus for automatically stirring and mixing the contents of a vessel, as recited in claim 1, wherein said stirring device further comprises a bent wire.

5. An apparatus for automatically stirring and mixing the contents of a vessel, as recited in claim 1, wherein said at least one vessel is a test tube.

6. An apparatus for automatically stirring and mixing the contents of a vessel, as recited in claim 1, wherein said means for supporting said at least one vessel further comprises a frame with at least one aperture, wherein said frame is connected to and is disposed between said base and said stirring device.

7. An apparatus for automatically stirring and mixing the contents of a vessel, as recited in claim 1, wherein said means for automatically aligning said stirring device comprises at least one stepper motor controlled by at least one microprocessor.

8. An apparatus for automatically stirring and mixing the contents of a vessel, as recited in claim 1, wherein said means for removably inserting said stirring device in said at least one vessel further comprises an extendible arm disposed between said stirring device and said movable arm.

9. An apparatus for automatically stirring and mixing the contents of a vessel, as recited in claim 1, further comprising means for inserting liquid into said vessel.

10. An apparatus for automatically stirring and mixing the contents of a vessel, as recited in claim 6, wherein said at least one vessel is removably supported by said frame which holds said at least one vessel in axial alignment with said stirring device.

11. An apparatus for automatically stirring and mixing the contents of a vessel, as recited in claim 1, wherein the location of said movable arm slidably connected to said base is movable along a generally horizontal and parallel plane with respect to an edge of said base.

12. An apparatus for automatically stirring and mixing the contents of a vessel, as recited in claim 1, wherein said means for automatically aligning said stirring device with said at least one vessel further comprises means for moving said stirring device along generally horizontal and perpendicular plane with respect to an edge of said base.

13. An apparatus for automatically stirring and mixing the contents of a vessel, as recited in claim 9, further comprising a pipette device for the delivery of fluids into said at least one vessel.

14. An apparatus for automatically stirring and mixing the contents of a vessel, as recited in claim 1, wherein said at least one vessel is a centrifuge tube.

15. An apparatus for automatically stirring and mixing the contents of a vessel, as recited in claim 1, wherein said means for removably inserting said stirring device in said at least one vessel comprises an extendible arm disposed between said movable arm and said at least one vessel wherein said stirring devices is disposed on the distal end of said extendible arm.

16. An apparatus for automatically stirring and mixing the contents of a vessel, as recited in claim 15, wherein said extendible arm is air powered.

17. An apparatus for automatically stirring and mixing the contents of a vessel, as recited in claim 15, wherein said extendible arm is hydraulically powered.

18. An apparatus for automatically stirring and mixing the contents of a vessel, as recited in claim 15, further comprising a switch disposed on said extendible arm wherein said switch senses when said stirring device is disposed within said at least one vessel.

19. An apparatus for automatically stirring and mixing the contents of a vessel, as recited in claim 13, further comprising vacuum means for withdrawing fluids from said at least one vessel.

20. An apparatus for automatically stirring and mixing the contents of a vessel, as recited in claim 19, wherein said stirring device, said pipette and said vacuum means are spaced parallel and apart on said extendible arm.

21. An apparatus for automatically stirring and mixing the contents of a vessel, as recited in claim 20, further comprising automated means for releasably maintaining control over said pipettes.

22. An apparatus for automatically stirring and mixing the contents of a vessel, as recited in claim 20, further comprising automated means for releasably maintaining control over said vacuum.

23. A method for automatically stirring and mixing the contents of a vessel, comprising the steps of:
a) inserting a vessel in an aperture of a frame which is connected to a base;
b) automatically detecting the location of said vessel on said frame;
c) automatically axially aligning a stirring device depended from a movable arm adjustably connected to said base with said vessel;
d) automatically inserting said stirring device into said vessel;
e) activating said stirring device to mix liquid disposed in said vessel; and,
f) withdrawing said stirring device from said vessel.

24. A method for automatically stirring and mixing the contents of a vessel, as recited in claim 23, further comprising the step, after step c, of inserting at least one liquid into said vessel.

25. A method for automatically stirring and mixing the contents of a vessel, as recited in claim 23, further comprising the step, after step e, of removing said mixed liquid from said vessel by vacuum.
